(19) United States
(12) Patent Application Publication
(10) Pub. No.: US 2005/0074329 A1
(43) Pub. Date: Apr. 7, 2005

(54) Pipes for steam power-plant

(76) Inventors: Colin G. Caro, London (GB); David D. A. Piesold, Kent (GB); William Tallis, London (GB)

Correspondence Address: James P Zeller;Marshall Gerstein & Borun, 6300 Sears Tower, 233 South Wacker Drive, Chicago, IL, 60606-6357, US

(21) Appl. No.: 10/478,030

(22) PCT Filed: May 17, 2002
(86) PCT No.: PCT/GB02/02339

(30) Foreign Application Priority Data
May 17, 2001 (GB) 0112064.1

(51) Int. Cl. F03B 1/00

(52) U.S. Cl. 415/182.1

(57) ABSTRACT

A turbine for use in electricity generation is provided with pipework for gas or vapor entering or leaving the turbine. The pipework includes a rigid section the centerline of which curves in three dimensions.

This invention relates to turbines, and more particularly to turbines for use in the generation of electricity.

Most generators used to produce electricity are driven by steam turbines. The turbines themselves are driven by steam produced in boilers heated by fossil fuels or by a nuclear reactor. It will normally not be possible to have a straight pipe leading from the outlet of the boiler to the inlet of the turbine, and so the pipework will generally consist of a number of lengths of straight pipe connected by bends, such as elbow bends.

Pipe fittings such as elbow bends normally cause head loss in the fluid flowing in the pipe. The head loss caused by fittings can be reduced by modification of the fittings; for example, the sweep of an elbow bend can be increased. However, it may not be possible to use elbow bends with a large sweep in the confines of a power generation plant. Further, there is still the problem that the mere presence of fittings of this type will contribute to head loss, and it will be appreciated that any amount of head loss, however small, can have a large effect on the total costs of generating electricity over the lifetime of a generation plant.

According to a first aspect of the present invention, there is provided a turbine for use in electricity generation, including pipework for gas or vapour entering or leaving the turbine, wherein the pipework comprises at least one substantially rigid pipe, having at least one section with a centreline curving in three dimensions.

In a normal elbow bend, in which the centreline of the pipe curves in two dimensions, the pressure at the inside of the curve is reduced in comparison to that at the outside of the curve. There is a resultant tendency for flow to separate from the inner wall of the curve, leading to energy losses caused by eddying turbulence. The flow separation may also result in cavitation at the inner wall, which can damage the pipe and reduce its useful working life.

However, in a tubular portion the centreline of which curves in three dimensions, swirl flow tends to develop. Under these circumstances, the axial velocity profile of the flow across the tubular portion becomes more uniform or “blunter”, with the speed of flow at the outside of the curve being less than it would be in similar flow in a two-dimensional curved pipe, and the speed at the inside being greater. Thus, the near wall velocity profile around the tubular portion tends to be circumferentially more uniform with its non-planar geometry than it would be with planar geometry (in a normal elbow bend). Since the velocity profile of the flow is more uniform, there is a reduced tendency for separation to occur at the inner wall of the curve, and this leads to reduced energy losses caused by eddying turbulence, and reduced risk of cavitation.

The reduction of the pressure drop which can be achieved using pipes having a centreline curving in three dimensions rather than elbow bends can be of significant economic importance with regard to turbines used for the generation of electricity.

In a preferred form, the turbine is a steam turbine, and the pipework is positioned between a boiler and the turbine. The reduction in pressure drop between the boiler and the turbine enables the steam to enter the turbine at a higher pressure, which can lead to higher efficiencies.

In a further preferred form, the turbine is a steam turbine, and the pipework is positioned between the exit of the turbine and a condenser.

The invention also extends to pipework for use with turbines as described above.

Pipes having a centreline curving in three dimensions can, for example, be used in the pipework carrying the exit steam from a condensing steam turbine in an electricity generation process. The steam is reduced to below atmospheric pressure so that as much of the energy in the steam as possible is extracted for electricity generation. Pipes having a centreline curving in three dimensions allow the pressure drop between the steam turbine exit and the condenser to be lowered, and this in turn allows the economic extraction of even more energy, thus improving the efficiency of the electrical generation process.

Such pipes can also be employed in the pipework conveying low pressure steam or other gases to an exhaust steam or gas turbine to generate electricity and in the exit pipework from such a turbine. In addition, the reduction in head loss achieved by using such pipes can be advantageously applied to other aspects of steam or gas turbines.

1. A turbine for use in electricity generation, including pipework for gas or vapor entering or leaving the turbine, wherein the pipework comprises at least one substantially rigid pipe, having at least one section with a centerline curving in three dimensions.

2. A turbine as claimed in claim 1, wherein said turbine is a steam turbine, and said pipework is positioned between a boiler and the turbine.

3. A turbine as claimed in claim 1, wherein said turbine is a steam turbine, and said pipework is positioned between the exit of the turbine and a condenser.

4. Pipework for use with a turbine as claimed in claim 1.
